(19) United States
(12) Patent Application Publication
(10) Pub. No.: US 2005/0255191 A1
(43) Pub. Date: Nov. 17, 2005

(54) Process for treating corn and millets

(76) Inventors: Donald Lee Shandera, Ashland, NE (US); Ki Park, Dayton, OH (US); Eugene M. Peters Jr, Kettering, OH (US); Aharon M. Eyal, Jerusalem (IL)

Correspondence Address: CARGILL, INCORPORATED, LAW/24, 15407 MCGINTY ROAD WEST, WAYZATA, MN, 55391, US

(21) Appl. No.: 10/521,121

(22) PCT Filed: Jul. 22, 2003
(86) PCT No.: PCT/US03/22953

§ 371 Date: Jan. 12, 2005

Related U.S. Application Data
(60) Provisional application No. 60/397,833, filed on Jul. 23, 2002.

(51) Int. Cl. A23L 1/10

(52) U.S. Cl. 426/18

(57) ABSTRACT

There is described a method of treating corn and/or millet(s) and parts thereof with an agent selected from non-protein, non-amino acid, non-vitamin, organic sulfur containing compounds; thiosulfate; and sodium dithionite. Also disclosed is a method for using the agent treated material in the production of starch products and fermentation feedstocks. Also disclosed is a method for using the agent treated material as a fermentation feedstock.

This application claims priority of Provisional Application Ser. No. 60/397,833 filed Jul. 23, 2002, the entire contents of which are incorporated herein by reference.

### FIELD OF THE INVENTION

The present invention relates to contacting corn and/or millet and parts thereof with at least one or more non-protein, non-amino acid, non-vitamin, organic sulfur containing compound(s); thiosulfate; and sodium dithionite.

### BACKGROUND OF THE INVENTION

Traditionally, cereals such as corn (maize) and millets (grain sorghum, pearl millet, and the like) have been processed either through wet milling, dry milling or extrusion. Most corn processed in the United States, however, is treated by the wet milling process. This process includes steeping the corn to soften the kernels for separation of the germ, followed by grinding and high-speed centrifugation and/or filtration to separate germ, protein, fiber and starch. Traditionally, the germ is subsequently processed to vegetable oil, and the protein and fiber are used for animal, avian, or fish feed, and the starch is used for many purposes such as sweetener or alcohol production.

During the traditional steeping process, the cereal material is commonly soaked in a solution comprising an aqueous medium containing gaseous sulfur dioxide (SO₂) and/or salts of sulfites to increase the yield and quality of the obtained starch. It has been recently found that environmental difficulties can result from the use of sulfur dioxide.

### SUMMARY OF THE INVENTION

The present process involves treating corn and/or millet(s) and parts thereof, in order to produce a treated corn and/or millet(s) and parts thereof. The process comprises treating the corn and/or millet(s) and parts thereof by contacting the corn and/or millet(s) and parts thereof with at least one agent selected from non-protein, non-amino acid, non-vitamin organic sulfur containing compound(s); thiosulfate; and sodium dithionite. The agent if desired may be used in the form of a liquid.

The present process is further related to using corn and/or millet(s) and parts thereof treated with the agent selected from non-protein, non-amino acid, non-vitamin organic sulfur containing compound(s); thiosulfate; and sodium dithionite in the production of a starch product.

The present process is further related to using corn and/or millet(s) and parts thereof treated with the non-protein, non-amino acid, non-vitamin organic sulfur containing compound(s); thiosulfate; and sodium dithionite in the production of a fermentation feedstock. Furthermore, the present process is related to using the corn and/or millet(s) and parts thereof treated with the agent as a fermentation feedstock.

### DETAILED DESCRIPTION OF THE INVENTION

The present process involves treating corn and/or millet(s) and parts thereof, in order to produce a treated corn and/or millet(s) and parts thereof. The process comprises treating the corn and/or millet(s) and parts thereof by contacting the corn and/or millet(s) and parts thereof with at least one agent selected from non-protein, non-amino acid, non-vitamin organic sulfur containing compound(s); thiosulfate; and sodium dithionite. The agent if desired may be used in the form of a liquid.

The present process is further related to using corn and/or millet(s) and parts thereof treated with the agent selected from non-protein, non-amino acid, non-vitamin organic sulfur containing compound(s); thiosulfate; and sodium dithionite in the production of a starch product.

The present process is further related to using corn and/or millet(s) and parts thereof treated with the non-protein, non-amino acid, non-vitamin organic sulfur containing compound(s); thiosulfate; and sodium dithionite in the production of a fermentation feedstock. Furthermore, the present process is related to using the corn and/or millet(s) and parts thereof treated with the agent as a fermentation feedstock.

The term “component” or “components”, used herein, includes corn and/or millet(s) and parts thereof. The term corn, used herein, includes maize. The term millet(s), used herein, includes any of the economically important small seeded annual grain and forage grasses commonly termed millet, including sorghum, pearl millet, proso millet, and the like.

In the present process the agent suitable for use in treating the components is any non-protein, non-amino acid, non-vitamin, organic sulfur containing compound; thiosulfate; and sodium dithionite. Examples of non-protein, non-amino acid, non-vitamin, organic sulfur containing compounds suitable for use in the process include thioglycolic acid, mercaptoethanol, bis(2-mercaptoethyl)sulfone, dithiothreitol, formamidinesulfinic acid, dithioerytheitol, dimethyl sulfide, thiourea, methyl mercaptan, 2-mercaptoethanesulfonic acid, 3-mercapto-1-propanol, 1-propanethiol, 2-propanethiol, thiolactic acid, thioglycerol, butyl mercaptan, benzenethiol, benzyl mercaptan, diethyldithiocarbamate, N-ethyhnaleimide, thiocyanate, and mixtures thereof. Preferred non-protein, non-amino acid, non-vitamin, organic sulfur containing compounds for use in the process include thioglycolic acid, mercaptoethanol, bis(2-mercaptoethyl)sulfone, dithiothreitol, formamidinesulfinic acid, dithioerytheitol, dimethyl sulfide, and thiourea By the term agent used herein is meant any non-protein, non-amino acid, non-vitamin, organic sulfur containing compound(s); sodium dithionite; thiosulfate; and mixtures thereof.

The component is contacted with the agent in any amount such as an amount of about 0.001 to about 2 mol agent per kg of component. There is no maximal amount. However, it is typical to contact the corn and/or millet and parts thereof with an amount of at least about 0.001 mol agent per kg of component, preferably about 0.002 to about 0.2 mol agent per kg of component.

The process for treating the component with the agent involves contact for any period of time such as at least about 1 minute. The optimal period of contact will depend on the concentration of the agent, temperature, pressure, and other variables obvious to those skilled in the art. As suitable temperature for contact is from about 0° C. to about 125° C. The amount of contact time will typically range from at least about 1 minute to about 72 hours. Preferably the contact time will range from at least about 15 minutes to about 48 hours.

The component may be contacted with the agent, in the present process, utilizing any technique suitable for achieving the contact. For example, the contacting may be carried out by mixing, immersing, soaking, spraying or misting. Moreover, the contacting may be carried out either batchwise or continuously.

The present process is also related to optionally treating the component in the presence of a liquid. The liquid used herein also may be any aqueous or organic solution or mixtures thereof. Preferred for use, however, is an aqueous solution comprising water and another compound such as a reducing agent.

The present process is also related to utilizing the component that has been treated with the agents of the present invention in the production of starch products. The starch products are obtained by subjecting the agent treated corn and/or millet and parts thereof to any conventional process such as wet processing or wet milling.

Any wet processing or wet milling process for treating a component may be utilized in the present process. Wet processing may entail a component or a product resulting from dry grinding and/or size reduction of the component. Wet processing of a component may be defined as processing a component wherein an amount of solution exceeding the amount that can be absorbed by the the component is used to enhance separation of the subparts of the component. Wet milling of a component may be defined as processing a component wherein an amount of water exceeding the amount that can be absorbed by the component is used to steep the component and then mill the component. Steeping of the component may be carried out in a manner similar to the aforementioned methods of treating the component with the agent. Preferably, the component will be soaked an amount of solution exceeding the amount that can be absorbed by the component. The wet processing and/or the wet milling of a component will provide a product comprising starch. Typically, the wet milling or wet processing of the component will produce a starch and or protein product stream with a higher concentration (% dry basis) of starch and or protein than the initial component.

For the purposes of this application, wet milling will be described herein in relation to the wet milling of corn. An exemplary process for carrying out the wet milling of corn is described as follows:

Corn is cleaned using a series of perforated screens of a size suitable to retain the corn and to allow removal of dust and debris. Clean corn is steeped in an aqueous solution originating from process water used in the mill containing the treating agent, at 49° C. (120° F.) for 30 hours in a 10 tank steep battery connected in series with a counter-current flow of the aqueous solution to the age of the steeping corn, with the aqueous solution first contacting the corn having the longest residence time in the battery. Approximately, 1.2 m³ of the aqueous solution per metric ton of corn (8 gallons of aqueous solution/bushel of corn) for steeping. After 30 hours of steeping, the corn and the aqueous solution, now enriched in corn solubles, are recovered as the steeped corn and light steep water product of steeping, respectively. The steeped corn product is ground in the presence of mill process water. Grinding of the steeped corn is performed in three stages. The first stage (herewith referred to as first grind) releases most of the germ from the steeped corn using a 91 cm (36 inch) grind mill fitted with Devil's toothed plates operating at 900 rpm. The slurry discharge from the first grind mill is pressure feed at approximately is 6.2 bars (90 psi) through a two-pass hydrocyclone battery consisting of 15.24 cm (6 inch) hydrocyclones to separate the germ. The separated germ is washed with mill process water and dried in a rotary drum drier to yield a dried germ product that can be further processed to yield oil and a extracted germ material used for feed. The remaining slurry from which most germ has been separated is milled again by coarsely grinding using a second 91 cm (36 inch) grind mill (herewith referred as second grind) fitted with Devil's toothed plates operating at 900 rpm to detach remaining germ from ground corn in the slurry. Freed germ present in the second grind discharge slurry is separated and recovered using hydrocyclones as described above. After the removal of germ, the remaining corn material is passed over 50 micrometer screen (referred to as third grind dewatering screen) to pass forward starch and protein collected as throughs. The corn material retained as overs by the screen is fine ground using a 36 inch grind mill (herewith referred as third grind) fitted with Devil's toothed plates operating at 1800 rpm. The fiber in the slurry of the third grind discharge is removed by a 7 stage screen separation system arranged such that the fiber is washed in a counter current flow of fiber to mill process water, where the cleanest fiber is washed with the mill process water added to the screen system. Washed fiber is discharged at the last stage (seventh stage), while starch and protein containing slurry is discharge at the first stage. The screen opening on the first fiber wash stage is 50 micrometer, followed by 75 micrometer on the second, 100 micrometer on stages 3-5, 125 micrometer on the sixth stage and 150 micrometer of the last stage. The washed fiber is dewatered using screw presses, and dried using a rotary drier, resulting in the dried fiber product. The discharge from the third grind dewatering screen and first stage fiber wash are combined, creating a slurry with a density of approximately 8 Baumè. This slurry is thickened with a Merco H36 centrifuge. This centrifuge operates at 2600 rpm and is fitted with No. 24 size nozzle. The overflow from the centrifuge is used as process water for steeping (also known as mill water), while the underflow slurry, having a Baumè of 12, is fed to a second H36 centrifuge (referred to as primary centrifuge). The starch-protein in the fed slurry is separated by the primary centrifuge. The primary centrifuge operates at 2200 rpm and is fitted with No. 24 nozzle to yield an underflow and overflow slurry. The overflow slurry is protein-enriched containing approximately 60% (db) protein, while the underflow slurry is starch enriched. The protein enriched overflow slurry from this centrifugation is then further dewatered by centrifugation with a third Merco H36 centrifuge operating at 2600 rpm, dewatered on a rotary drum filter and dried using a flash drier. This results in the protein rich product, also known as corn gluten meal. The starch enriched slurry originating from the underflow of the second Merco H36 centrifuge described above is passed through a 12 stage Dorr-Oliver clam shell hydrocyclone starch wash battery. The starch wash battery is designed such that a counter-current flow between the starch enriched stream entering the first stage of the battery and potable water entering at the 12^{th} stage of the battery is achieved. Each stage starch wash stage has several 10 mm hydroclones arranged in parallel fashion. A concentrated starch slurry with a density of 23 Baumè is recovered as underflow from the 12^{th} stage of the starch wash battery. Typical feed pressure to each starch wash stage, except the 12^{th} stage, is 6.2 bar (90 psi); the feed pressure on the 12^{th} stage is 8.27 bar (120 psi).

Further information regarding the wet milling of corn is found in Technology of Corn Wet Milling and Associated Processes p. 69-125, Paul H. Blanchard, Elsevier Science Publishers B.V. Amsterdam. A suitable method for wet milling of sorghum can be found in: Starch: Chemistry and Technology pp. 417-468, Roy Whisler, James BeMiller, Eugene Paschall, ed. In a similar manner, other millets can be processed.

The present process is also related to utilizing the component that has been treated with the agents of the present invention in the production of fermentation feedstock. The feedstock is obtained by subjecting the agent treated component to any conventional process such as wet milling or wet processing to obtain a concentrated starch and/or protein product that can be used as a feedstock for fermentation. In a further embodiment, the concentrated starch product may be further subjected to chemical and/or enzymatic hydrolysis and be utilized as such as a feedstock for fermentation.

As an example of a method for producing a fermentation feedstock, the following is provided. The starch slurry produced from the agent treated component by the previously described wet milling process may be optionally hydrolyzed for incorporation into the fermentation feedstock. The starch slurry may be hydrolyzed by any conventional manner. For example, starch slurry may be hydrolyzed by subjecting the starch slurry to acid hydrolysis. Typically acids will include inorganic acids such as hydrochloric acid and the like. Elevated temperatures increase the rate of hydrolysis and may be varied over a wide range depending on the degree of hydrolysis desired. Acid hydrolysis is limited in the extent of starch hydrolysis possible. If one wishes to exceed that level of hydrolysis, one must use other means of hydrolysis such as enzymatic digestion of the starch with starch hydrolyzing enzymes.

An exemplary process for carrying out starch hydrolysis by acid hydrolysis is described as follows:
a) starch slurry with a 23 Be′ is provided;
b) the pH of the slurry is adjusted to 1.8 with 22 Be′ hydrochloric acid;
c) the slurry with pH 1.8 is introduced into a converter at 295° F. for 18 minutes; and
d) the pH of the converted starch is then adjusted to pH 4.8 with 10% soda ash and cooled.
e) a 85 DE syrup hydrolyzate is achieved.

An exemplary process for starch hydrolysis by enzyme liquefaction/enzyme saccharification is described as follows:
1) Liquefaction: Water is added to the starch to adjust dry solid content to 35%. The pH of slurry is adjusted to 5.5 using sodium hydroxide solution. Calcium chloride is added to the slurry to have the minimum of 5 ppm of free calcium ions. Termamyl Supra (amylase from Novozymes North America, Inc) is added to this pH adjusted slurry at the amount of 0.4 liter per metric ton of starch dry solids. Then, the mixture is heated in a continuous jet cooker to 108° C. and held for 5 minutes in a pressurized vessel. Then the cooked mixture is cooled to 95° C. and held for 100 minutes. Hydrolyzate with a DE of 8 to 12 is achieved at this point.
2) Saccharification: Starch hydrolyzate from the above liquefaction step is cooled to 60° C. and the dry solid content is adjusted to 32% by adding water. The pH of this diluted hydrolyzate is adjusted to 4.1-4.3 using sulfuric acid. Dextrozyme E (mixture of amyloglucosidase and pullunase from Novozymes North America, Inc) is added at the amount of 0.7 liters per metric ton of dry solids and then the mixture is held for 40 hours. Dextrose content of 95-97%, on the dry solid basis, is achieved.

Further information regarding starch hydrolysis is found in Technology of Corn Wet Milling and Associated Processes p. 217-266, Paul H. Blanchard, Elsevier Science Publishers B.V. Amsterdam.

In the present invention any enzyme capable of hydrolyzing a corn and/or millet(s) component may be used. Examples of component hydrolyzing enzymes include starch hydrolyzing enzymes (for example amylases, glucoamylase, pullulanases), protein hydrolyzing enzymes (for example proteases, peptidases), fiber hydrolyzing enzymes (for example cellulases, xylanases) and phytate hydrolyzing enzymes (for example phytases).

In treating the component in the present invention, excess agent may be present within the products produced from the agent treated component. It is possible that the residual agent may have undesirable effects in use of the product, such as inhibitory effects on microbial growth if the product is to be used as a fermentation feedstock. A method to reduce these undesirable effects on product use is to oxidize the residual agent present in the product. For example, the fermentation feedstock product is treated with enough peroxide to oxidize the residual agent. Additionally, the pH of the fermentation feedstock may be raised to an alkaline pH to enhance the susceptibility of the agents to oxidation. Any suitable oxidizing or alkalating agent may be used.

The following examples are presented to illustrate the present invention and to assist one of ordinary skill in making and using the same. The examples are not intended in any way to otherwise limit the scope of the invention.

### EXAMPLES

In carrying out the following example, the following test procedures were used:

% Starch Recovery from Corn

This is a procedure for measuring the percentage starch recovery of the original starch content from corn. The agent treated corn was divided into 2 equivalent volume fractions. Each fraction was ground separately with 220 milliliters of added distilled water using a model 700S Waring blender, available from Waring Laboratory, Torrington, Conn. The Waring blender was fitted with the standard 1 liter sized stainless steel blender jar with its cutting blades reversed so that the blunt side of blade impacted the corn. The blender was operated at 3000 revolutions per minute for 2 minutes, then at 4000 revolutions per minute for 2 minute for each corn fraction ground separately. The two ground fractions were then commingled in a 1-liter beaker and stirred to allow the germ to float to the top of the ground mixture. Floating germ were skimmed by hand with a 12 mesh (1.70 millimeter opening) wire screen. Skimmed germ were placed on a No. 12 U.S. wire (1.70 millimeter opening) sieve, and washed with 1 liter of distilled water of which the used wash water was saved for adding back to slurry during bran separation. Degermed slurry was then ground in a Quaker City 4 inch grind mill, model no. 4-E, Straub Co., Warminster, Pa., with the grinding plates adjusted to contact each other. The ground slurry was then consecutively sieved over a No. 60 (250 micrometer opening) and No. 325 (45 micrometer opening) U.S. wire sieves to separate bran (fiber) from the starch and protein in the slurry. Bran was washed with an additional 2 liters of distilled water and the 1 liter of water saved during the previous germ washing step. The solids of the degermed and debranned protein-starch slurry were allowed to settle at room temperature for 1 hour. A quantity of liquid was decanted from the settled protein-starch-slurry such that a 5.5 Baumè slurry was produced upon re-suspension of the settled starch and protein solids. Starch was then separated from protein by tabling the 5.5 Baumè adjusted protein-starch slurry. The aforementioned decanted volume was set aside for further usage in washing starch. The protein-starch slurry was pumped at a rate of 50 milliliters per minute onto a 0.0508 meter wide by 2.44 meters length (2 inch by 8 feet long) aluminum table inclined 0.0254 meter (1 inch) at the feeding end of the table. After the 5.5 Baumè protein-starch slurry was finished pumping onto the table, the approximately 3 liters of previously decanted water that had been set aside was consecutively pumped onto the feeding end of the table at a rate of 50 milliliters per minute. Subsequently, an additional 1 liter fresh distilled water was pumped onto the feeding end of the table at a rate of 50 milliliters per minute to wash the starch settled onto the table. The starch was then allowed to air-dry overnight on the starch table. After air-drying overnight, the starch was collected and vacuum dried at 85° C. and at −25 mm Hg for 24 hours. A sample of the original corn was also simultaneously vacuum dried for determination of moisture content and dry solids content for calculation of starch recovery. Starch content of the original corn was determined by official method CRA-20 of the Corn Refiners Association. Starch recovery was calculated on a percentage basis from original corn kernel dry-basis weight and starch content as:
% starch recovery=(wt. dry starch)/((wt. corn treated with agent (dry basis))×(% starch content))×100
% Starch Recovery from Sorghum

The procedure for determining % Starch Recovery from sorghum is that utilized to determine % Starch Recovery from Corn except for the following modifications.

Since the germ does not have a density that allows it to float and be separated from bran, there is no germ to be skimmed by a No. 12 mesh (1.70 millimeter opening) screen. Subsequently, there is no germ to be washed on a No. 12 sieve with 1 liter of distilled water. An additional amount of 1 liter water is added to the bran washing step. The Baumè for tabling is adjusted to the fact that sorghum is being used instead of corn. In all other aspects, the procedure for determining the % starch recovery from sorghum is carried out in accordance with the procedure described above for determining the % Starch Recovery from Corn.

% Starch Recovery from Pearl Millet

The procedure for determining % Starch Recovery from pearl millet is that utilized to determine % Starch Recovery from Corn except for the following modifications. Since the germ does not have a density that allows it to float and be separated from bran, there is no germ to be skimmed by a No. 12 mesh (1.70 millimeter opening) screen. Subsequently, there is no germ to be washed on a No. 12 sieve with 1 liter of distilled water. An additional amount of 1 liter water is added to the bran washing step. The Baumè for tabling is adjusted to the fact that pearl millet is being used instead of corn. In all other aspects, the procedure for determining the % starch recovery from pearl millet is carried out in accordance with the procedure described above for determining the % Starch Recovery from Corn.

% Protein Content in Starch

This is a procedure for measuring the protein content in the recovered starch. The protein content of the recovered starch was measured by the official analytical method AACC 46-30 of the American Association of Cereal Chemists. A total nitrogen to crude protein conversion factor of 6.25 was used.

### Example 1

A yellow No. 2 dent corn was cleaned over a No. 4 U.S. wire (7.5 millimeter opening) sieve to remove broken kernels and chaff. Physically or heat damaged kernels were removed by hand.

There was prepared agent treated corn by combining, in 500 ml sealed jars, 200 grams of the cleaned corn with 300 milliliter of an aqueous solution individually containing an amount as listed below of each of the agents identified below.

In this example as the agents, there were utilized thioglycolic acid at 0.120 mol/kg corn, mercaptoethanol at 0.048 mol/kg corn, dithiothreitol at 0.024 mol/kg corn, and bis(2-mercaptoethyl)sulfone at 0.006 mol/kg corn.

The jars containing the corn and aqueous solution were incubated at 23° C. for 40 hours with mixing by inversion of the containers after periods of 30 minutes, 1 hr, 2 hr, 12 hr, 24 hr, and 36 hr. After 40 hrs of treatment, the aqueous solution was drained from corn by pouring the contents of the plastic jar over a No. 12 U.S. wire sieve (1.70 millimeter opening) to separate the solution from the treated corn.

As a control basis for testing the effects of the agents, corn was also treated with sodium bisulfite at 0.120, 0.048, 0.024, and 0.006 mol/kg corn.

For purposes of evaluation, the various treated corn were subjected to the procedure for determining % Starch Recovery from Corn. The protein content of the starch product produced during execution of the % Starch Recovery from Corn procedure were then evaluated by the % Protein Content in Starch procedure.

The results are reported in the following Tables 1 and 2.

TABLE 1
% Starch Recovery from the Treated Corn

| | | Starch | |
|---|---|---|---|
| | Level | Recovery from | % Increase in |
| Treating Agent | (mol/kg corn) | Corn (%, db) | Starch Yield |
| Thioglycolic acid | 0.120 | 91.09 | 8.8% |
| Sodium Bisulfite | 0.120 | 83.06 | |
| Mercaptoethanol | 0.048 | 91.56 | 5.5% |
| Sodium Bisulfite | 0.048 | 86.52 | |
| Dithiothreitol | 0.024 | 91.18 | 11.5% |
| Sodium Bisulfite | 0.024 | 80.67 | |
| Bis(2-mercaptoethyl) | 0.006 | 88.22 | 18.1% |
| sulfone | | | |
| Sodium Bisulfite | 0.006 | 72.26 | |

TABLE 2
% Protein Content of Starch Recovered from Treated Corn

| | | Protein | % Difference |
|---|---|---|---|
| | | Content in | in Starch |
| | Level | Starch | Protein |
| Treating Agent | (mol/kg corn) | (%, db) | Content |
| Thioglycolic acid | 0.120 | 0.34 | 0 |
| Sodium Bisulfite | 0.120 | 0.34 | |
| Mercaptoethanol | 0.048 | 0.33 | 2.9% |
| Sodium Bisulfite | 0.048 | 0.34 | |
| Dithiothreitol | 0.024 | 0.33 | 13.2% |
| Sodium Bisulfite | 0.024 | 0.38 | |
| Bis(2-mercaptoethyl) | 0.006 | 0.31 | 22.5% |
| sulfone | | | |
| Sodium Bisulfite | 0.006 | 0.40 | |

From the above data shown in table 1, it is observed that corn treated with agents exhibited higher starch recovery yields than corn treated with comparable sodium bisulfite concentrations. It is noted that the amount by which the starch recovery yields are increased, range from about 5 to 18%,

Also from the above data shown in table 2, it is observed that the protein content of the starch produced from the corn treated with the agents have at least as low a protein content as starch produced from corn treated with comparable sodium bisulfite concentrations. Protein content of starch is a well known quality measurement of starch produced from the wet milling of corn. Protein is a contaminant of wet milled starch. It is generally known that higher protein content in starch often has a negative impact on its end use properties, and there is an economic cost to remove the protein from the starch if it is to be used for applications requiring low protein content, such as food starch and sweetner uses. It is noted that the percent protein content of the starch obtained from the corn treated with the agents was from 0% to as much as 22.5% lower than the starch obtained from comparable sodium bisulfite treated corn. In the above tables of data, corn treated with sodium bisulfite was used as the control. This is a well-known technique for treating corn in order to enhance starch recovery and decrease protein content of the recovered starch.

### Example 2

The procedure of example 1 is followed except that corn is replaced with sorghum. It is expected that similar results in relation to % Starch Recovery and % Starch Protein Content will be obtained.

### Example 3

The procedure of example 1 is followed except that corn is replaced with pearl millet. It is expected that similar results in relation to % Starch Recovery and % Starch Protein Content will be obtained.

The invention has been described with reference to various specific and illustrative embodiments and techniques. However, one skilled in the art will recognize that many variations and modifications may be made while remaining within the spirit and scope of the invention.

1. A process for treating a component selected from the group consisting of corn and/or millet(s) and parts thereof comprising:
a) providing the component; and
b) contacting the component with at least one or more agent(s) selected from the group consisting of non-protein, non-amino acid, non-vitamin, organic sulfur containing compounds; thiosulfate; and sodium dithionite.

2. The process according to claim 1, wherein the agent is utilized in a liquid form.

3. The process according to claim 1 further comprising contacting the agent treated component with a solution.

4. The process according to claim 3 wherein the solution is selected from the group consisting of an aqueous solution, an organic solution, and mixtures thereof.

5. The process according to claim 4 wherein the solution comprises water.

6. The process according to claim 1 wherein the agent is a non-protein, non-amino acid, non-vitamin organic sulfur containing compound selected from the group consisting of thioglycolic acid, mercaptoethanol, bis(2-mercaptoethyl)sulfone, dithiothreitol, formamidinesulfinic acid, dithioerytheitol, dimethyl sulfide, thiourea, methyl mercaptan, 2-mercaptoethanesulfonic acid, 3-mercapto-1-propanol, 1-propanethiol, 2-propanethiol, thiolactic acid, thioglycerol, butyl mercaptan, benzenethiol, benzyl mercaptan, diethyldithiocarbamate, N-ethylmaleimide, thiocyanate, and mixtures thereof.

7. The process according to claim 6 wherein the agent is dithiothreitol.

8. The process according to claim 6 wherein the agent is mercaptoethanol.

9. The process according to claim 6 wherein the agent is thioglycolic acid.

10. The process according to claim 6 wherein the agent is dimethyl sulfide.

11. The process according to claim 6 wherein the agent is bis(2-mercaptoethlyl)sulfone.

12. The process according to claim 6 wherein the agent is thiourea.

13. The process according to claim 6 wherein the agent is thiolactic acid.

14. The process according to claim 1 wherein the component is contacted with an amount of agent of at least 0.001 mole/kg component.

15. The process according to claim 1 wherein the component is contacted with an amount of agent of at least 0.001 mole/kg component to about 2 mole/kg component.

16. The process according to claim 1 wherein the component is contacted with the agent for a period of at least about 1 minute.

17. The process according to claim 1 wherein the component is contacted with the agent for a period of at least about 1 minute to about 72 hours.

18. A process for producing a starch product comprising using the treated component of claim 1.

19. A process for producing a fermentation feedstock comprising using the treated component of claim 1.

20. A process for using the treated component of claim 19 as a fermentation feedstock.

21. A fermentation feedstock produced according to claim 19.
